(19) United States
(12) Patent Application Publication
(10) Pub. No.: US 2019/0000246 A1
(43) Pub. Date: Jan. 3, 2019

(54) Display Stand

(71) Applicants: William Holmes, Grasonville, MD (US); Lisa Holmes, Grasonville, MD (US)

(72) Inventors: William Holmes, Grasonville, MD (US); Lisa Holmes, Grasonville, MD (US)

(21) Appl. No.: 15/878,964

(22) Filed: Jan. 24, 2018

Related U.S. Application Data
(60) Provisional application No. 62/528,002, filed on Jun. 30, 2017.

(51) Int. Cl. A47G 1/14; F16B 2/12; F16B 2/00

(52) U.S. Cl. CPC A47G 1/14; A47G 2001/148; F16B 2/005; F16B 2/12

(57) ABSTRACT

A display stand for securement of a photograph to a surface. The display stand is provided having a base with a bottom surface with an adhesive thereon. The display stand includes a screw that selectively moves a middle panel along a rail from a clamped to an unclamped position. A gripping surface is provided on the middle panel and a front surface.

### CROSS REFERENCE TO RELATED APPLICATIONS

This application claims the benefit of U.S. Provisional Application No. 62/528,002 filed on Jun. 30, 2017. The above identified patent application is herein incorporated by reference in its entirety to provide continuity of disclosure.

### BACKGROUND OF THE INVENTION

The present invention relates to photographic display stands. Specifically, the present invention relates to display stands that remain in a relative static position in a moving vehicle.

Many people who travel in recreational vehicles (RV(s)) or boats enjoy decorating the interior of these vehicles with photographs or other stationary items. However, when in transit, these decorative become unstable and create an unsafe condition. Therefore, most individuals that travel in RV's and boats need to stow their interior decorations during transit. Thus, a display stand that does not need to be stowed in transit is desirable, especially one that can secure items of varying sizes.

Several devices have been proposed to aid in the display of decorative objects. One such device is a screw vise having a weighted base. This device, however, fails to provide an adhesive on a lower surface of the display stand, thereby preventing the display stand from sliding, wobbling or falling from its placed location.

### SUMMARY OF THE INVENTION

In view of the foregoing disadvantages inherent in the known types of display stands now present in the prior art, the present invention provides a display stand wherein the same can be utilized for providing convenience for the user when displaying photographs or other objects in a moving vehicle. The present system comprises a base having a top and bottom surface. An adhesive is disposed on the bottom surface thereof. A front wall and a back wall extend perpendicularly upwards from the base. A middle panel is slidably disposed between the front wall and the back wall. A screw is threaded through an aperture in the back wall and is fastened to the middle panel, wherein rotation of the screw forces the middle panel to selectively move between the front wall and the back wall.

One object of the present invention is to provide a display stand that has an adhesive on a bottom surface thereof to secure the display stand to a surface of a vehicle when in transit.

Another object of the present invention is to provide a display stand that is a screw vise.

A further object of the present invention is to provide a display stand that is a screw vise, wherein a gripping pad is affixed to the surfaces of the vise that contact an object held in the vise.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the display stand.

FIG. 1B shows an alternative perspective view from the rear of an embodiment of the display stand.

FIG. 2 Shows a perspective view of a second embodiment of the display stand.

FIG. 3 Shows a perspective view of an embodiment of the display stand in use.

### DETAILED DESCRIPTION OF THE INVENTION

Reference is made herein to the attached drawings. Like reference numerals are used throughout the drawings to depict like or similar elements of the display stand. The figures are intended for representative purposes only and should not be considered to be limiting in any respect. Unless specifically limited to a single unit, “a” is intended to be equivalent to “one or more” throughout the present disclosure.

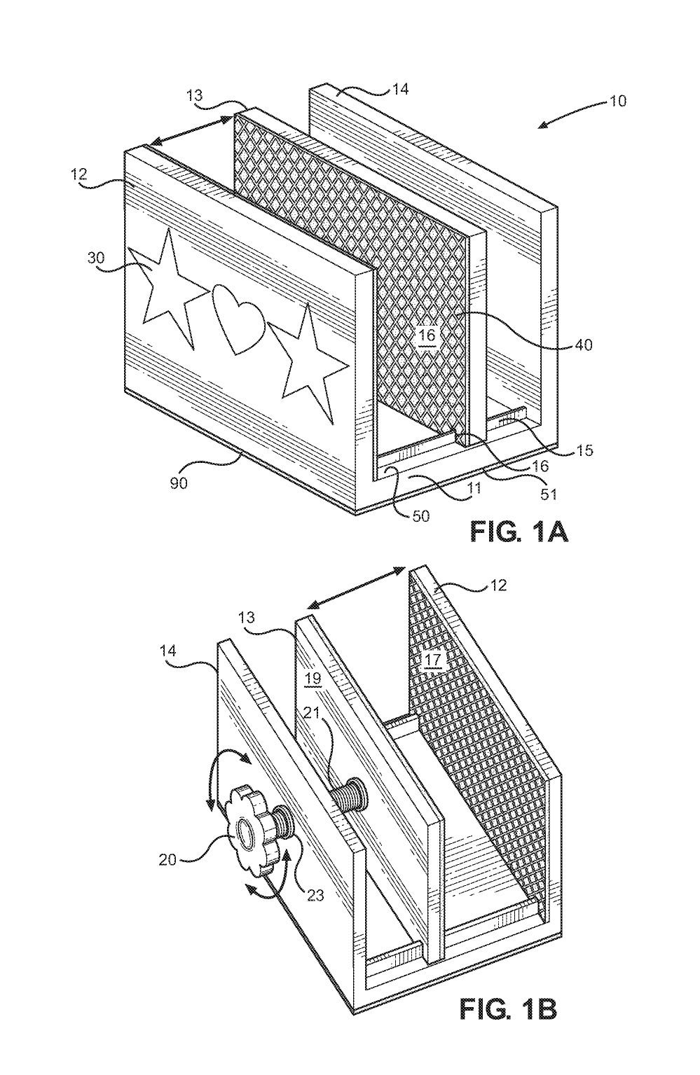

Referring now to FIG. 1A, there is shown a perspective view of an embodiment of the display stand. The display stand 10 comprises a base 11 having a top surface 50 opposed to a bottom surface 51. The top 50 and bottom surfaces 51 are planar. An adhesive 90 is disposed on the bottom surface. The adhesive 90 is configured to the display stand 10 to a surface, such as a shelf or dashboard, in a vehicle.

A front wall 12 and a back wall 14 extend upwards from the base 11, wherein the front 12 and back wall 14 are perpendicular to the base 11. The front wall 12 and back wall 14 extend upwards from opposing ends of the base 11. In the shown embodiment, a graphic indicia 30 is disposed on the front wall 12. Further, the graphic indicia 30 is placed on a surface of the front wall 12 that faces away from the back wall 14.

A middle panel 13 is disposed between the front wall 12 and the back wall 14, wherein the middle panel 13 selectively moves between the front wall 12 and the back wall 14. The middle panel 13 slides along a rail 15 disposed on the top surface 50 of the base 11. The rail 15 runs from the front wall 12 to the back wall 14 and perpendicularly intersects both the front wall 12 and the back wall 14. The middle panel 13 has a groove 16 formed therein, wherein the groove receives the rail 15 in a tongue-and-groove type connection. This tongue-and-groove type connection ensures the middle panel 13 only moves along an axis between the front wall 12 and the back wall 14, as defined by the rail 15. In the illustrated embodiment, the middle panel 13, front wall 12 and back wall 14 are of equivalent dimensions. Further, the middle panel 13 is dimensioned to fit entirely within a boundary formed by the front wall 12 and the back wall 14.

Now referring to FIG. 1B, there is shown an alternative perspective view from the rear of an embodiment of the display stand. A screw 21 is affixed to the middle panel 13, wherein the screw 21 extends from a rear surface 19 of the middle panel 13. In the shown embodiment, the screw 21 is affixed to the middle panel 13 by a bearing, which allows the screw 21 to rotate pursuant to its threading. The screw 21 is threaded through an aperture 23 in the back wall 14. A knob 20 is affixed to the screw 21 on an end opposite the middle panel 13, wherein the back wall 14 is between the middle panel 13 and the knob 20. Rotation of the knob 20 turns the screw 21, thereby applying a force to the middle panel 13, which moves the middle panel 13 either toward or away from the front wall 12, depending on the direction of rotation of the knob 20. In this way, the middle panel 13 and front wall 12 act as the jaws of a vise.

A shown in FIG. 1A and FIG. 1B, a gripping pad 40 is disposed on each of an inner surface 17 of the front wall 12 and a front surface 16 of the middle panel 13. As shown, the gripping pads 40 can be textured, e.g. by cross hatching. In one embodiment, the gripping pads 40 are composed of silicone or rubber.

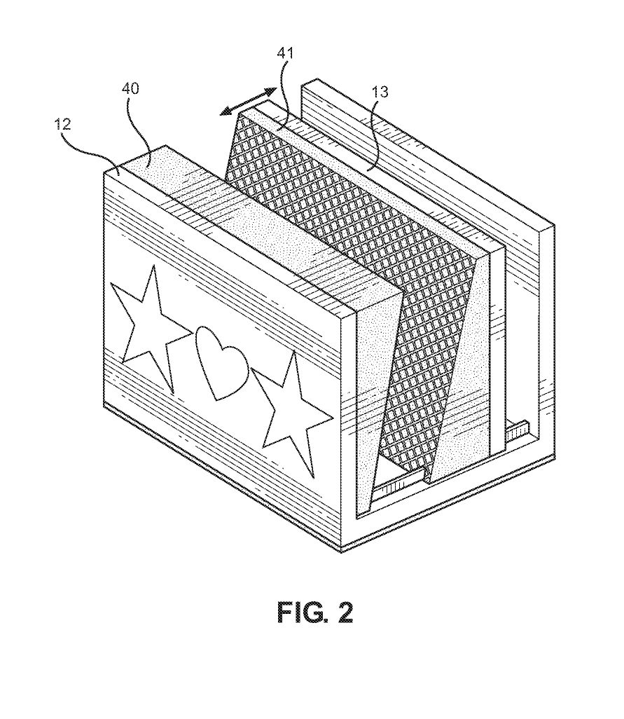

Now referring to FIG. 2, there is shown a perspective view of a second embodiment of the display stand. In this embodiment, the gripping pad 40 affixed to the front wall 12 tapers toward the base 11, specifically toward the intersection where the front wall 12 meets the base 11. The gripping pad 40 affixed to the middle panel 13 is complementary tapered to the gripping pad 40 affixed to the front wall 12. Meaning, the gripping pad 40 affixed to the middle panel 23 tapers toward the top of the middle panel 13 at a slope that is parallel to the slope of the taper of the gripping pad 40 affixed to the front wall 12. In other embodiments, there is no gripping pad 40 and the front surface 16 of the middle panel 13 and the inner surface 17 of the front wall 12 are formed with complementary slopes.

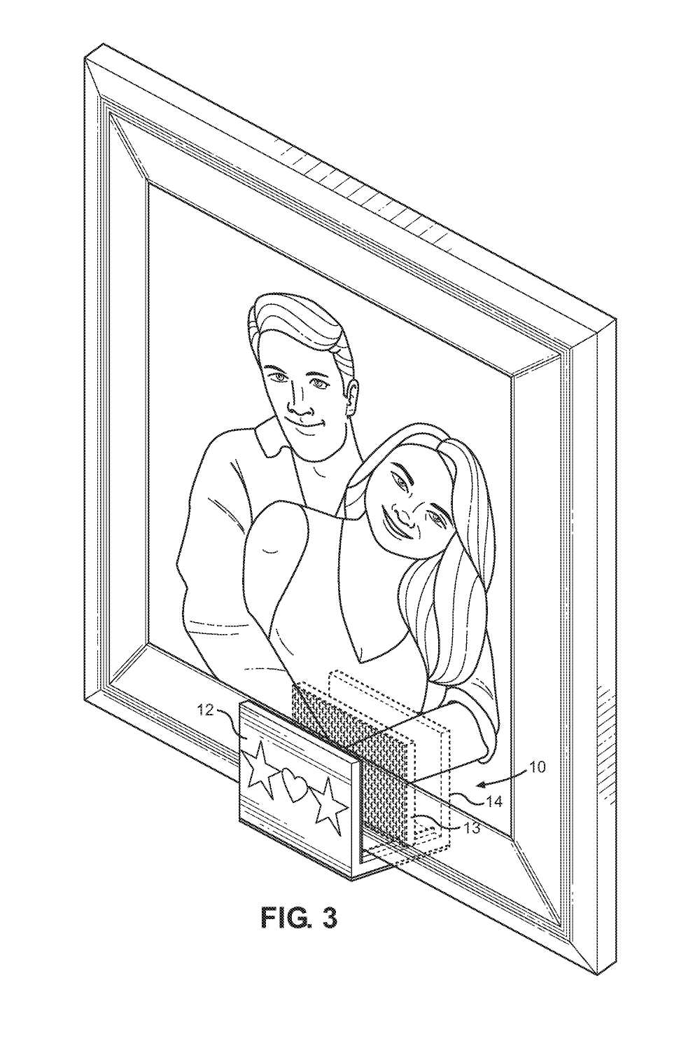

Now referring to FIG. 3, there is shown a perspective view of an embodiment of the display stand 10 in use. Due to the selective movement of the middle panel 13 back and forth between the front wall 12 and the back wall 14, the display stand 10 can hold items of varying sizes. For example, the display stand 10 can hold a photograph stable, even if the photograph is in a bulky frame.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A display stand, comprising:
a base having a front wall and a back wall, wherein the front wall and the back wall extend perpendicularly upwards from opposing ends of the base;
wherein the front wall and the back wall are integral to the base;
wherein the top surface of the base and the bottom surface of the base are planar;
a middle panel slidably disposed between the front wall and the back wall, wherein the sliding middle panel is configured to selectively move between the front wall and the back wall;
a screw affixed to the middle panel and threaded through an aperture in the back wall, wherein rotation of the screw forces the sliding middle panel to move;
an adhesive disposed on a bottom surface of the base such as to removable secure the base to a support surface.

2) The display stand of claim 1, wherein a track is affixed to a top surface of the base, wherein the middle panel slides over the track.

3) The display stand of claim 1, wherein an inner surface of the front wall and a front surface of the sliding middle panel each have a gripping pad affixed thereon.

4) The display stand of claim 1, wherein a knob is affixed to the screw, wherein the back wall is between the knob and the middle panel.

5) The display stand of claim 1, wherein a graphical indicia is disposed on the front wall.

6) The display stand of claim 3, wherein the gripping pad affixed to the inner surface of the front wall is tapered toward the base and the gripping pad affixed to the front surface of the middle panel is complementary tapered away from the base.

7) The display stand of claim 2, wherein the middle panel slidably engages the track via a pair of lateral rails on the base extending entirely between the front wall and the back wall.

8) The display stand of claim 1, wherein the middle panel is dimensioned to fit entirely within a boundary formed by the front wall and the back wall.

9) The display stand of claim 3, wherein the middle panel and the front wall are configured to selectively secure a picture frame therein, wherein the selectively secured picture frame remains oriented perpendicular to the base.

10) The display stand of claim 1, wherein the aperture is centrally disposed and internally threaded relative to the screw, such that rotation in a first rotation causes sliding of the middle panel.

11) The display stand of claim 2, wherein the track comprises a tongue-in-groove configuration wherein a tongue is disposed on a top surface of the base and a corresponding groove is disposed in a bottom portion of the middle panel.

12) The display stand of claim 3, wherein the gripping pad comprises a textured surface.

13) The display stand of claim 12, wherein the gripping pad comprises cross-hatching thereon.

14) The display stand of claim 1, wherein the front wall, the back wall and the middle panel are of an identical size and an identical shape.
